(19) United States
(12) Patent Application Publication
(10) Pub. No.: US 2011/0057620 A1
(43) Pub. Date: Mar. 10, 2011

(54) CHARGE/DISCHARGE PROTECTION CIRCUIT AND DISCHARGING PROTECTION METHOD

(75) Inventors: Tsung-Cheng TSAI, HSINCHU COUNTY (TW); In-Ming CHIU, HSINCHU HSIEN (TW); Ya-Mei CHANG, HSINCHU HSIEN (TW); Yu-Pin KAO, HSINCHU HSIEN (TW)

(73) Assignee: SIMPLO TECHNOLOGY CO., LTD., HSINCHU HSIEN (TW)

(21) Appl. No.: 12/607,994

(22) Filed: Oct. 29, 2009

(30) Foreign Application Priority Data
Sep. 8, 2009 (TW) 98130257

(51) Int. Cl. H02J 7/00; H02J 7/04

(52) U.S. Cl. 320/134; 320/162

(57) ABSTRACT

A charge/discharge protection circuit adapted in an electronic apparatus and a discharge protection method are provided. The charge/discharge protection circuit comprises a positive electrode, a ground for discharging, a switch module, a battery module, a negative electrode for charging, a sensing device and a control module. The battery module is electrically connected to the switch module and the ground to form a discharging path. The switch module is electrically connected to the positive electrode. The sensing device is electrically connected to the battery module and the negative electrode to form a charging path. The sensing device passively disconnects the charging path when the charging path is abnormal. The control module actively turns the switch open when the discharging path, the charging path or the battery module is abnormal.

### RELATED APPLICATIONS

This application claims priority to Taiwan Application Serial Number 98130257, filed Sep. 8, 2009, which is herein incorporated by reference.

### BACKGROUND

1. Technical Field

The present disclosure relates to a protection circuit. More particularly, the present disclosure relates to a charge/discharge protection circuit.

2. Description of Related Art

Most battery modules adapted in electronic apparatus nowadays can both charge and discharge. The battery module provides power to the electronic apparatus through by discharging process. On the other hand, a charging module in the electronic device charges the battery module through charging process. A larger current is generated charging process when the battery module discharges. However, the electronic apparatus dissipates the large current generated during the discharging process. Thus, the chance that the discharging process causes damage to the battery module is negligible. In contrast, though the current generated during the charging process of the battery module is quite small compared to the discharging process, the battery module may not be able to tolerate a slightly larger current or a higher temperature. When the current is a bit too large or the temperature is a bit too high, the battery module may be damaged. Furthermore, if the battery module burns because of the large current or the high temperature, it may injure the user of the electronic apparatus, which is an undesirable result. Therefore, a module to monitor the charging path during the charging process and disconnecting the charging path in time to prevent the occurrence of the dangerous result is needed.

In the conventional design, the charging path is substantially the same as the discharging path. When the said module detects an abnormal situation, such as a large current or a high temperature, the said module controls a switch on the path to disconnect the path during the charging or discharging process. However, if the said module itself is not able to properly operate, the battery module doesn't have another backup protection mechanism to prevent damage caused by the abnormal current/temperature situation.

Thus, a new charge/discharge protection circuit is needed to provide the battery module an improved protection mechanism. The present disclosure addresses such a need.

### SUMMARY

An object of the present disclosure is to provide a charge/discharge protection circuit adapted in an electronic apparatus, wherein the charge/discharge protection circuit comprises: a positive electrode, a ground for discharging, a switch module, a battery module, a negative electrode, a sensing device, and a control module. The switch module is electrically connected to the positive electrode. The battery module is electrically connected to the switch module and the ground for discharging to form a discharging path. The negative electrode is for charging. The sensing device is electrically connected to the battery module and the negative electrode to form a charging path together with the positive electrode, the switch module, the battery module and the negative electrode, wherein the sensing device passively disconnects the charging path when the charging path is abnormal. The control module actively turns the switch module open when the discharging path, the charging path or the battery module is abnormal.

Another object of the present disclosure is to provide a charging protection method adapted in a charge/discharge protection circuit comprising a charging path and a discharging path, wherein the charging protection method comprises the steps of: connecting the charging path to charge a battery module on the charging path; detecting whether the charging path or the battery module is abnormal; when the charging path or the battery module is abnormal, determining whether a switch module on the charging path is able to disconnect the charging path; and when the switch module is able to disconnect the charging path, the switch module turns open to actively disconnect the charging path; when the switch module is unable to disconnect the charging path, a sensing device on the charging path passively turns open to disconnect the charging path.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a circuit diagram of a charge/discharge protection circuit in an embodiment of the present disclosure;

FIG. 2 is a circuit diagram of the charge/discharge protection circuit in another embodiment of the present disclosure; and

FIG. 3 is a flow chart of the charging protection method in yet another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

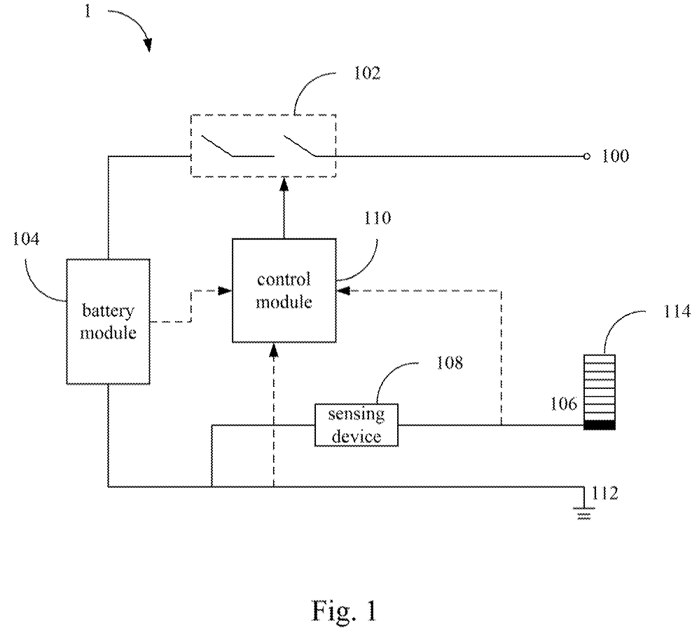

Please refer to FIG. 1. FIG. 1 is a circuit diagram of a charge/discharge protection circuit 1 in an embodiment of the present disclosure.

The charge/discharge protection circuit 1 comprises: a positive electrode 100, a switch module 102, a battery module 104, a negative electrode 106, a sensing device 108, a control module 110 and a ground 112 for discharging. The charge/discharge protection circuit 1 is adapted in an electronic apparatus (not shown), wherein the battery module 104 in the charge/discharge protection circuit 1 provides power to the electronic apparatus. In contrast, a charging module (not shown) in the electronic apparatus is able to charge the battery module 104.

The switch module 102 is electrically connected to the positive electrode 100. The switch module 102 has two switches in FIG. 1. However, in different embodiments, the number of switches can be adjusted to fit the needs.

In the present embodiment, the battery module 104 is electrically connected to the switch module 102 and the ground 112 for discharging to form a discharging path together with the positive electrode 100, the switch module 102 and the ground 112. The positive electrode 100 and the ground 112 are further electrically connected to the electronic apparatus to provide the power of the electronic apparatus when the battery module 104 discharges through the discharging path.

The negative electrode 106 is for charging. The sensing device 108 is electrically connected to the battery module 104 and the negative electrode 106 to form a charging path together with the positive electrode 100, the switch module 102, the battery module 104 and the negative electrode 106. The positive electrode 100 and the negative electrode 106 are electrically connected to the charging module of the electronic apparatus. The charging module is able to charge the battery module 104 through the charging path.

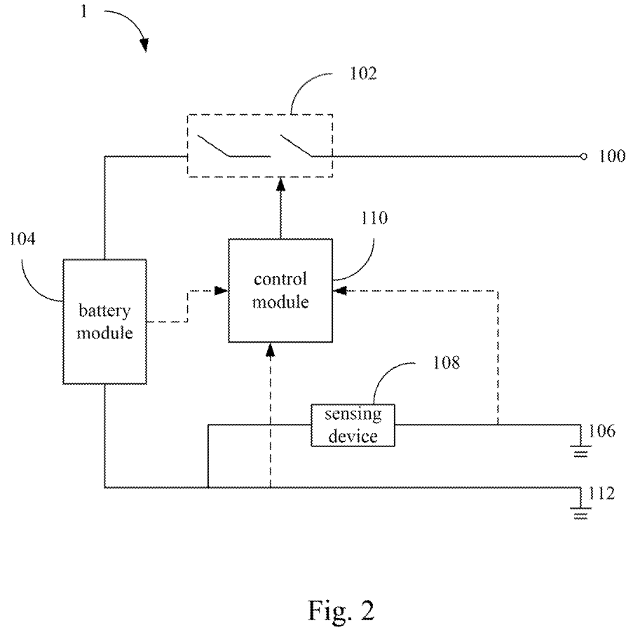

The negative electrode 106 in the present embodiment is a pin of the communication port, wherein the pin can belong to an I² C, a USB, a RS232 or a RS485 communication port. In different embodiment, the communication port can be a specific pin for charging solely or a data communication pin, such as a differential data communication pin, that is able to perform charging as well. In the later embodiment, there is no need to place an additional pin, which is an additional cost. FIG. 2 is a circuit diagram of the charge/discharge protection circuit 1 in another embodiment of the present disclosure. In FIG. 2, the negative electrode 106 is a ground 106 for charging, wherein the charging path and the discharging path has different grounds 106 and 112 respectively.

Please refer to FIG. 1 again. The control module 110 is able to actively turn the switch module 102 open when the discharging path, the charging path or the battery module 104 is abnormal. The abnormal situation can be an over-current or an over-temperature condition of the charging or the discharging path that is able to do harm to the elements of the charge/discharge protection circuit 1 or the electronic apparatus. A larger current is generated during the discharging activity of the battery module 104. However, the large current generated during the discharging activity is dissipated by the electronic apparatus. Thus, the discharging activity does no harm to the battery module 104. In contrast, though the current generated during the charging activity of the battery module 104 is quite small compared to the discharging activity, the battery module 104 may not be able to stand for a slightly larger current or a higher temperature. When the current is a bit too large or the temperature is a bit too high, the battery module 104 suffers damage. Therefore, the control module 110 is mainly used to protect the charging path, since the abnormal situation on the charging path is much more dangerous than on the discharging path. The control module 110 is to actively turn the switch module 102 open to further disconnect the charging path when the abnormal situation occurs.

However, if the control module 110 itself is not able to properly operate, the charging path will not be disconnected when there is an abnormal situation. If there is no other backup protection mechanism to disconnect the charging path, the battery module 104, or even the electronic apparatus may suffer from the damage caused by the abnormal situation.

The sensing device 108 provides the backup protection mechanism to passively disconnect the charging path when the charging path is abnormal. In an embodiment, the sensing device 108 is a fuse that is able to break when the current of the charging path becomes larger than a value that the fuse is not able to stand for to passively disconnect the charging path. In another embodiment, the sensing device 108 is a temperature-sensing device or a temperature-controlled device that is able to break when the temperature of the charging path (especially the battery module 104) becomes larger than a value that the sensing device 108 is not able to stand for to passively disconnect the charging path. The devices described above are usually low power elements that are suitable to be placed on the charging path that generates a smaller current. Therefore, the sensing device 108 is able to provide a simple mechanism to passively disconnect the charging path when the control module 110 is not able to properly operate.

The number of the switches in the switch module 102 and the type of the battery module can be modified according to the different situations in different embodiments. It will be apparent to those skilled in the art that various modifications and variations can be made to the structure of the present disclosure without departing from the scope or spirit of the disclosure.

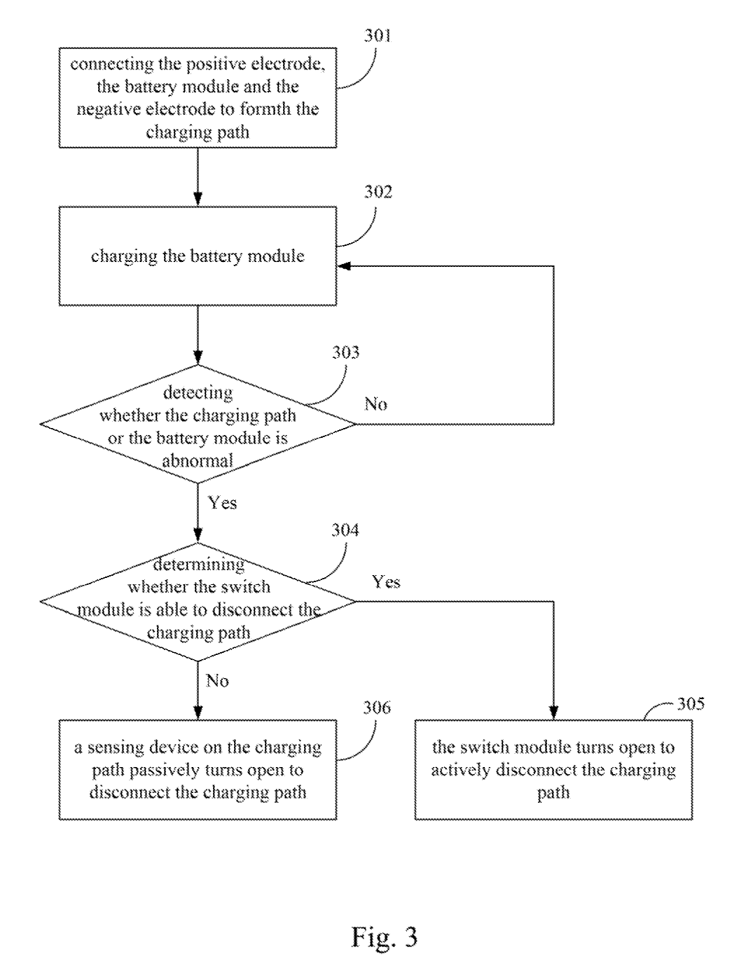

Yet another embodiment of the present disclosure is a charging protection method adapted in the charge/discharge protection circuit 1 depicted in FIG. 1 or in FIG. 2. Please refer to FIG. 3. FIG. 3 is a flow chart of the charging protection method. The charging protection method comprises the following steps. In step 301, the positive electrode 100, the battery module 104 and the negative electrode 106 are connected to form the charging path. In step 302, the battery module 104 is charged. In step 303, the charging path or the battery module 104 are monitored to detect abnormalities. When the charging path and the battery module are not abnormal, the step 302 is performed to keep charging the battery module 104. When the charging path or the battery module is abnormal, step 304 is performed to determine whether the switch module 102 on the charging path is able to disconnect the charging path. When the switch module 102 is able to disconnect the charging path, the switch module 102 is opened to actively disconnect the charging path in step 305. On the other hand, when the switch module 102 is unable to disconnect the charging path, the sensing device 108 on the charging path is passively turned open to disconnect the charging path in step 306.

The advantage of the present disclosure is to separate the charging and the discharging path and to place the low-power sensing device on the charging path to passively break the charging path when the control module is not able to properly operate to provide the protection mechanism.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A charge/discharge protection circuit adapted in an electronic apparatus, wherein the charge/discharge protection circuit comprises:
a positive electrode;
a ground for discharging;
a switch module electrically connected to the positive electrode;
a battery module electrically connected to the switch module and the ground for discharging to form a discharging path;
a negative electrode for charging;
to a sensing device electrically connected to the battery module and the negative electrode to form a charging path together with the positive electrode, the switch module, the battery module and the negative electrode, wherein the sensing device passively disconnects the charging path when the charging path is abnormal; and
a control module to actively turn the switch module open when the discharging path, the charging path or the battery module is abnormal.

2. The charge/discharge protection circuit of claim 1, wherein the sensing device is a fuse to disconnect the charging path when the current of the charging path is abnormal.

3. The charge/discharge protection circuit of claim 1, wherein the sensing device is a temperature-sensing device or a temperature-controlled device to disconnect the charging path when the temperature of the charging path is abnormal.

4. The charge/discharge protection circuit of claim 1, wherein the negative electrode for charging is a ground for charging.

5. The charge/discharge protection circuit of claim 1, wherein the negative electrode for charging is a pin of a communication port of the electronic apparatus.

6. The charge/discharge protection circuit of claim 5, wherein the pin of the communication port is the pin of an I² C, a USB, a RS-232 or a RS-485 communication port.

7. The charge/discharge protection circuit of claim 5, wherein the pin of the communication port is a charging pin.

8. The charge/discharge protection circuit of claim 5, wherein the pin of the communication port is a differential data communication pin.

9. The charge/discharge protection circuit of claim 1, wherein the positive electrode and the ground for discharging are further connected to the electronic apparatus to provide the power to the electronic apparatus according to the battery module through the discharging path.

10. The charge/discharge protection circuit of claim 1, wherein the positive electrode and the negative electrode are further connected to a charging module of the electronic apparatus to charge the battery module according to the charging module through the charging path.

11. A charging protection method adapted in a charge/discharge protection circuit comprising a charging path and a discharging path, wherein the charging protection method comprises the steps of:
connecting the charging path to charge a battery module on the charging path;
detecting whether the charging path or the battery module is abnormal;
to when the charging path or the battery module is abnormal, determining whether a switch module on the charging path is able to disconnect the charging path; and
when the switch module is able to disconnect the charging path, the switch module turns open to actively disconnect the charging path;
when the switch module is unable to disconnect the charging path, a sensing device on the charging path passively turns open to disconnect the charging path.

12. The charging protection method of claim 11, wherein the sensing device is a fuse to disconnect the charging path when the current of the charging path is abnormal.

13. The charging protection method of claim 11, wherein the sensing device is a temperature-sensing device or a temperature-controlled device to disconnect the charging path when the temperature of the charging path is abnormal.

14. The charging protection method of claim 11, wherein the step of making the switch module turns open to actively disconnect the charging path is performed by a control module.

15. The charging protection method of claim 11, wherein the charging path comprises a negative electrode.

16. The charging protection method of claim 15, wherein the negative electrode for charging is a ground for charging.

17. The charging protection method of claim 15, wherein the negative electrode for charging is a pin of a communication port of the electronic apparatus.

18. The charging protection method of claim 17, wherein the pin of the communication port is the pin of a I² C, a USB, a RS232 or a RS485 communication port.

19. The charging protection method of claim 17, wherein the pin of the communication port is a charging pin.

20. The charging protection method of claim 17, wherein the pin of the communication port is a differential data communication pin.
